(19) United States
(12) Patent Application Publication
(10) Pub. No.: US 2011/0180506 A1
(43) Pub. Date: Jul. 28, 2011

(54) GANTRY CANE

(75) Inventor: Peter Lerchenmuller, Hard (AT)

(73) Assignee: HANS KUNZ GESELLSCHAFT M.B.H., Hard (AT)

(21) Appl. No.: 13/121,720

(22) PCT Filed: Sep. 8, 2009
(86) PCT No.: PCT/AT2009/000352

§ 371 Date: Mar. 30, 2011

(30) Foreign Application Priority Data
Oct. 9, 2008 (AT) 1577/2008

(51) Int. Cl. B66C 19/00; B66C 9/16

(52) U.S. Cl. 212/276

(57) ABSTRACT

On a gantry crane having a carriage which is used to displace the gantry crane along a straight track formed by parallel rails (1) and which includes a plurality of carriage groups (11), which each have at least two wheels (12) mounted rotatably on a subframe (16) and spaced apart from each other in the longitudinal direction of the respective rail (1) and of which at least two, preferably all, are connected rotatably about a vertical axis (23) to an end carriage (10) of the gantry crane, at least one measuring device (26) is present for at least one carriage group (11) connected rotatably about the vertical axis (23) to the associated end carriage (10). The measuring device can detect a track position of at least one of the wheels (12) of the carriage group (11) with respect to the rail (1) on which it rolls and can output a track position value (a) that corresponds to the respective track position. An actuator (28) acting between the carriage group (11) and the associated end carriage (10) is controlled by a regulating device (48, 49), to which the track position value (a) output by the measuring device (26) is fed. The carriage group (11) can be subjected by the actuator (28) to a torque (m) about the vertical axis (23) that is determined by the control.

### BACKGROUND

The invention relates to a gantry crane, comprising a carriage, which serves to displace the gantry crane along a straight track formed by parallel rails, and which comprises a plurality of carriage groups, each of which having at least two wheels mounted rotationally on a subframe and disposed at a distance from each other in the longitudinal direction of the respective rail and of which at least two, and preferably all, are connected rotationally about a vertical axis to an end carriage of the gantry crane, with at least one measuring device being present for at least one carriage group connected rotationally about the vertical axis to the associated end carriage, and preferably for all carriage groups connected to the respectively corresponding end carriage, rotational about the respective vertical axis, wherein said measuring device can detect the track position of at least one of the wheels of the carriage group with respect to the rail on which it rolls and can output a track position value that corresponds to the respective track position.

The carriages of gantry cranes are displaceable on rails and comprise carriage groups for each leg of the gantry crane. The carriage groups comprise wheels for displacing the crane, with some or all of them being equipped with drive engines.

There are types of cranes different from gantry cranes, such as overhead cranes, which comprise elevated support rails and in which the support construction and the carriage of the crane are located on the same level.

In a prior art embodiment of a gantry crane, the individual carriage groups are connected to an end carriage of the steel construction of the crane in a single degree of freedom only, namely rotational about a horizontal axis positioned perpendicular in reference to the rails. In practice, this leads to more or less severely sloped positions of the axes in reference to their exact alignments perpendicular in reference to the longitudinal extension of the rails due to tolerances and deformations of the parts. The horizontal forces resulting and their disadvantageous distribution upon the individual wheels lead to carriage torque and thus to an increased wear and tear of the wheel flanges as well as the tread of the wheels and the rails.

In order to reduce this wear and tear, constructions are known in which an additional degree of freedom is provided for aligning the carriage group to the end carriage, namely a rotation about a vertical axis. Such a gantry crane is known from EP 1 911 716 A2. For a rotary connection of a respective carriage group to the corresponding end carriage, rotational both about a horizontal axis arranged perpendicular in reference to the rails as well as about a vertical axis, a second joint is provided, which is embodied in the vertical direction as a floating bearing, and with a guide being provided arranged perpendicular in reference to the longitudinal extension of a respective rail on the side opposite the central joint, which is connected on the one side to a carriage group and on the other side to the end carriage via joints located over top of each other, by which both pressures as well as tensile forces can be transferred. Here, the central joint can be embodied, in particular as a type of ball joint.

Additionally, other constructions for connections of a carriage group to the end carriage are known, either rotational both about a horizontal axis located perpendicularly in reference to the rails or about a vertical axis. For example, such constructions provide for the use of a slewing ring or slewing roller pins, a friction bearing with an additional counter fastener, an axial ball bearing with additional counter bearings, or a central joint in the form of a spherical pressure bearing with tensile rods being arranged at both sides of the central joint between the end carriage and the carriage group. These constructions are sometimes quite expensive.

In spite of the connection of the carriage groups, rotational about the vertical axis, to the corresponding end carriages it usually occurs, particularly in cranes with long traveling distances, that the wheel flanges contact the rail flanks, depending on the play of the wheel flanges and the axial deviations of the wheels. In the best case scenario, which cannot be realized in practice, the carriage group travels along a sinus curve, thus the wheel flanges alternatively contact the two rail flanks with relatively low forces. In practice, by deviations of the axis of the wheels of a carriage group from their precisely parallel alignment in reference to each other, in the following called “diagonal alignment of the wheels”, horizontal forces develop which act in the sense of a torque of the carriage group about the vertical axis. This leads to one of the two wheel flanges, particularly the one of the leading wheel of a respective carriage group in the direction of motion, approaching the respective rail flange and thus to an increased wear and tear of said wheel flange. An approaching of the respective wheel flanges can also be caused by deviations from a precisely straight alignment of the rails. In practice, the reconditioning of worn wheel flanges leads to considerable expenses for the operation of gantry cranes.

An extension of the life can be achieved by guide rollers rotational about their vertical axes, by which the wheels are guided in reference to the rails. However, the initial equipment leads to high costs and considerable maintenance costs arise from the wear of the rollers and such equipment is not always possible, e.g., in case of rails mounted flush to the ground.

Further, an installation of lubricators is known, in order to reduce friction between the wheel flanges and the rail flanks. However, the effectiveness is not particularly high and the rapid wear of the lubricators leads to high maintenance expenses.

In addition to “straight carriages” for displacing a gantry crane along rails positioned in a straight line, non-generic curved carriages are known which serve to displace a crane along a track comprising at least one curve.

A synchronizing device is known for carriages of overhead cranes, in which a leading wheel is scanned and the drives allocated to the two rails are controlled such that the desired alignment of the crane carriage is achieved in reference to the rails. Such a synchronizing device is possible for the commonly rigid embodiment of overhead cranes.

From DE 25 28 293 A1, from one of the exemplary embodiments described there, a gantry crane of the type mentioned at the outset is discernible, in which the rotations of the engines of the drives, allocated to the two rails, are controlled in order to regulate the straight run.

### SUMMARY

The object of the invention is a considerable cost reduction over the life of the gantry crane. This is achieved according to a gantry crane having the features of the invention.

In a gantry crane according to the invention an actuator is provided for at least one carriage group connected to the corresponding end carriage and rotational about the vertical axis, by which the carriage group can be impinged with a torque about the vertical axis, which torque is determined by the control of the actuator via a control device. Accordingly, this relates to a force-controlled actuator, which causes a torque around the vertical axis, about which the carriage group can be rotated, according to the force created thereby. Preferably, at least one force-controlled actuator acts upon each of the carriage groups, which are rotational about a vertical axis in reference to the corresponding end carriage.

By a measurement device a track position value is provided to the control device in order to control the actuator by said control device. Within the scope of the present publication, the position of the wheel in reference to the rail compared to the direction perpendicular to the longitudinal direction of the rail is called the track position. This track position is detected by the measurement device for at least one of the wheels of said carriage group, positioned in front of the vertical axis in reference to the respective direction of travel, about which the carriage group can be rotated in reference to the end carriage, upon which the actuator acts and a measurement (=track position value) is output from the measurement device to the control device as a variable for the respective track position at said time. Depending on the track position value fed to the control device, it adjusts the momentary impingement of the actuator acting upon the carriage group. The torque caused by the actuator and acting about the vertical axis therefore represents the variable of the control circuit. Preferably the measurement device detects the track position of the leading wheel for the respective travel direction.

Due to the impingement with torque according to the invention, the wheel flanges can be kept at a distance from the rail flanks, either entirely or at least to a large extent (e.g. over more than 90% of the traveling distance). This achieves a considerable reduction in wear and tear, namely in a very simple fashion without any mandatory control adjusting the rotary position of a carriage group in reference to the vertical axis. Impinging a respective carriage group with torque occurs via a control, with the actual track position value of the wheel, detected by the measurement device for the present traveling direction, being used as the variable.

In an advantageous embodiment of the invention, for a central range of the track position of the wheel detected by the measurement device, with in this central range the wheel flanges being spaced apart from the rail flanks, e.g., by at least 3 mm, the torque impinged by the actuator upon the carriage group is set to the value 0 by the control device, i.e. no torque is impinged by the actuator upon the carriage group and/or the carriage group is released with regards to a rotation about the vertical axis. When during the displacement of the gantry crane the position of the wheel track on one side reaches a location outside this central range, the actuator will impinge a torque upon the carriage group. Here, it may be beneficial to provide that the amount of the impinged torque is a constant value, regardless of the extent the track position of the wheel is outside said central range. For right and left deviations in reference to the central range, the direction of the force enacted by the actuator is reversed, i.e. the direction of rotation of the torque is reversed. The amount of the torque impinged may be equal or different for left and right deviations in reference to the central range. This way, a very simple control can be achieved.

### BRIEF DESCRIPTION OF THE DRAWINGS

In the following, additional advantages and details of the invention are explained using the attached drawing. Shown here:

FIGS. 1 and 2: a front view and a top view of a gantry crane according to an exemplary embodiment of the invention, very schematically and simplified;

FIG. 3: a side view (viewing direction A in FIG. 1) of a carriage group connected to an end carriage and a rail;

FIG. 4: a section of the end carriage and a rocker arm connected to the end carriage in a side view, taken in a direction of view B in FIG. 3 (without the joint element to connect the end carriage to the rocker arm);

FIG. 5 a schematic, enlarged view of a section of a subframe in the area of the measurement device, in a side view according to FIG. 3 (without the drive engine);

FIG. 6 a schematic view of the measurement device in a side view (according to the direction of view B in FIG. 3);

FIG. 7 a schematic view of a part of the leading wheel for the respective drive direction without an upper section of the rail, in a side view according to the direction of view B in FIG. 3;

FIG. 8 a schematic view of the control circuit in an exemplary embodiment;

FIG. 9 exemplary graphs of the position of the track in reference to time (above view) and the torque impinged by the actuator in reference to the time (lower view) to illustrate the control.

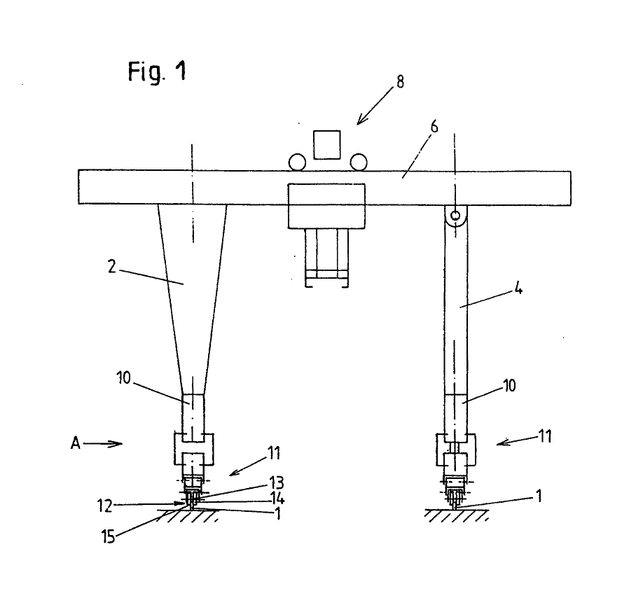

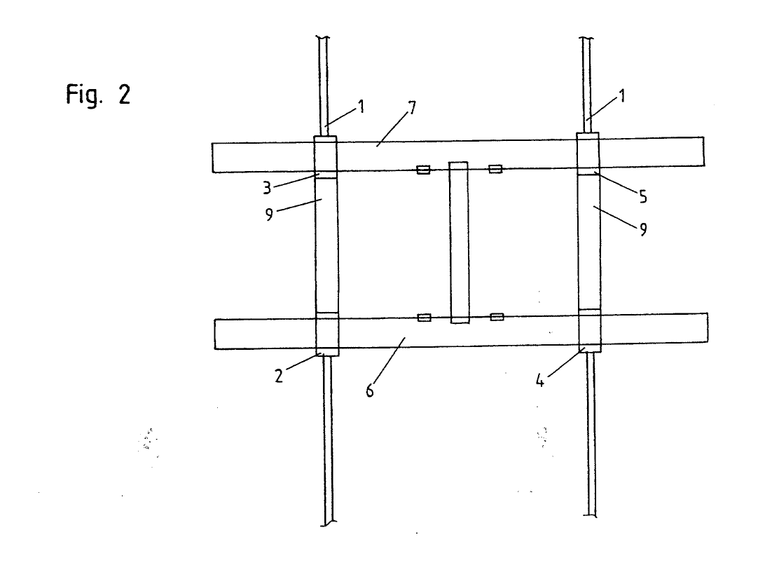

### DETAILED DESCRIPTION OF THE PREFERRED EMBODIMENTS

An exemplary embodiment of a gantry crane embodied according to the invention is shown in the figures. The gantry crane is displaceable on a straight track, which is formed by two parallel rails 1 installed at a distance in reference to each other. In the exemplary embodiment shown, the gantry crane comprises four legs 2, 3, 4, 5. Constructions with 3 legs are also known. Additionally, two supports may also be provided. The legs 2-5 and/or supports carry the transverse beam or beams 6, 7, along which a trolley 8 is displaceable or which is provided with a type of displaceable or fixed lifting device. In case of an embodiment with two or more transverse beams 6, 7, connection beams 9 extend between them.

At the lower ends of the legs 2, 3; 4, 5, arranged at the respective sides of the gantry, an end carriage 10 is arranged connecting them. Such an end carriage 10 is also called a “bogie girder” or “track girder”. The end carriage 10 serve to connect the steel construction of the crane to the individual carriage groups 11 of the crane carriages. The crane carriage is a straight carriage for displacement along the rails 1 extending in a straight fashion.

Preferably, a carriage group 1 is arranged directly below each of the legs 2-5. In general it is also possible, for example, to provide a separate end carriage 10 for each leg 2-5. Preferably at least two carriage groups 11 are provided for each rail 1, spaced apart in the longitudinal direction of the rail 1. An arrangement below the respective leg 2-5 is preferred.

All wheels 12 of a respective carriage group 11 are arranged successively on a straight line formed by the rail 1. The axes 13 of the wheels 12 are aligned almost perpendicularly in reference to the rails 1 (in all possible rotational positions of the carriage group 11 in reference to the vertical axis 23, explained in the following, the deviation amounts for example to less than 3°, with this value depending on the geometry of the carriage group; deviations of the axial positions of the wheels 12 of a carriage group 11 in reference to its alignment parallel in reference to each other are preferably smaller than 0.05°).

In the exemplary embodiment shown, a respective carriage group 11 comprises eight wheels 12, spaced apart from each other in the longitudinal direction of the rail 1.

Two wheels 12, each arranged successively in the longitudinal direction of the rails, are supported rotationally at a subframe 16. Therefore, in the exemplary embodiment shown, four subframes 16 are provided per carriage group positioned successively in the longitudinal direction of the rails.

Two subframes 16, positioned successively in the longitudinal direction of the rails, are connected to a common rocker arm 17. Therefore, in the exemplary embodiment shown, two rocker arms 17 are provided spaced apart in the longitudinal direction of the rails 1. The subframes 16 are connected to the rocker arms 17, rotational about axes 18 positioned parallel in reference to the axes 13 of the wheels 12.

The two rocker arms 17 are connected by a common rocker arm 19, each rotational in reference to the rocker arm 19 about a horizontal axis 20 positioned parallel in reference to the axes 13 of the wheels 12.

Drive engines 21 serve to displace the crane along the rails 1, driving the respective wheels 12. Depending on the application, more or fewer drive engines 21 may be provided.

The respective end carriage 10 is connected to the respective carriage group 11 in a manner such that the carriage group 11 is rotational in reference to the end carriage 10 about a horizontal axis 24 positioned perpendicular in reference to the respective rail 1, and rotational about a vertical axis 23. For this purpose a connection device 25 is provided, which may be embodied according to prior art as stated at the outset. Particularly preferred is an embodiment known from EP 1 911 716 A2, with a central joint 22 being provided, preferably embodied in the form of a ball joint, and further two guides 29, 30 being arranged between the respective end carriage 10 and the respective carriage group 11, which are positioned at both sides of a central joint 22 seen in the direction perpendicular in reference to the rail 1. Each of the two guides 29, 30 are connected in an articulate fashion to the end carriage 10 as well as the rocker arm 19. These joints 31, 32 of the guides 29, 30, positioned above each other, are here embodied such that, via the guides 29, 30, both pressures as well as tensile forces can be transferred between the respective end carriage 10 and the respective carriage group 11.

Here, these joints 31, 32 each comprise a degree of freedom for rotating the respective guide 29, 30 in reference to the end carriage 10 and/or in reference to the rocker arm 19 about an axis 33 positioned parallel in reference to the axes 13 of the wheels 12 and a degree of freedom for rotating the respective guide 29, 30 in reference to the end carriage 10 and/or in reference to the carriage group 11 about a horizontal axis 34 positioned perpendicular in reference to the axes 13 of the wheels 12. The central joint 22 is embodied as a floating bearing in the vertical direction, i.e. in the mounted state it has play in this direction.

A carriage group 11 of a gantry crane embodied according to the invention may also comprise more or fewer than eight wheels 12, spaced apart in reference to each other in the driving direction, with at least two wheels 12 being provided, spaced apart from each other in the longitudinal direction of the respective rail 1, supported rotationally at a common subframe 16. In case of an embodiment of the carriage group 11 with only a single subframe 16, the connection device 25 may be arranged directly between this subframe 16 and the end carriage 10. For example, in a carriage with four wheels 12 arranged successively in the driving direction two wheels each may be supported rotationally at a respective subframe 16 and the subframe 16 may be connected to a rocker arm 17 rotational about axes located parallel in reference to the axes 13 of the wheels 12. In this case, the connection device 25 may be arranged directly between the end carriage 10 and the rocker arm 17.

Within the carriage group 11, the wheels 12 are fixed in reference to rotation about vertical axes, i.e. except from the rotation of the carriage group 11 in its entirety about the vertical axis 23 no rotations are possible about vertical axes, e.g., of individual wheels 12.

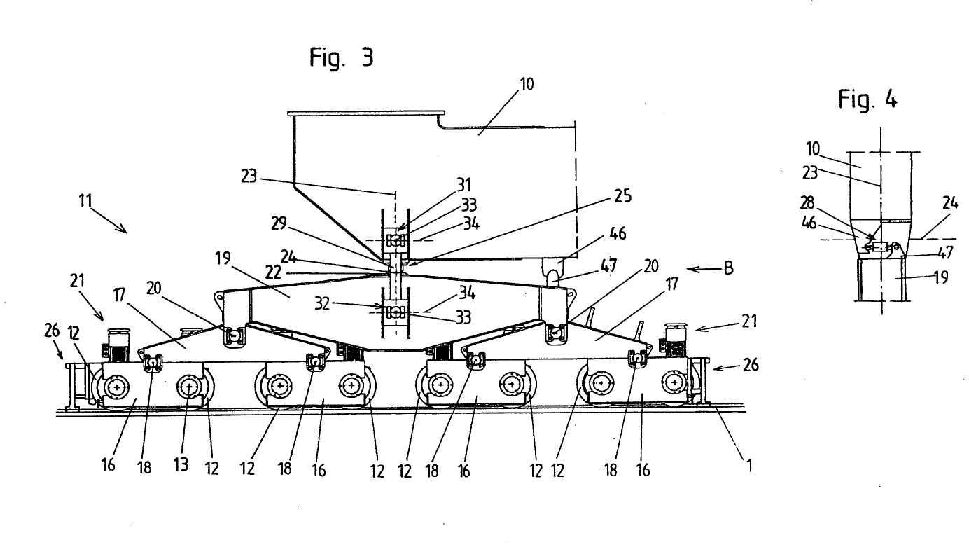

At least the leading wheel 12 in the driving direction and the one leading in the opposite direction, i.e. the wheel positioned in FIG. 3 at the very left and the very right of a carriage group 11, are rotational about a vertical axis 23, and are preferably provided with wheel flanges 14, 15, as discernible from FIG. 7. The wheels 12 positioned therebetween may also be provided with wheel flanges 14, 15. Instead, wheels without wheel flanges may be used for the intermittent wheels 12, as well. Here it is then advantageous to provide a derailment guard (embodied as known in prior art by stops arranged at the subframe, which cooperate with the rail flanges), which can achieve cost savings in reference to wheels with wheel flanges. In general, wheels without wheel flanges may also be used for the leading wheels in reference to the driving direction provided with a derailment guard, with here wheels with wheel flanges being preferred for safety reasons, though. Instead of wheels 12 with wheel flanges 14, 15, wheels 12 with track guiding rollers may also be used, which are also known from prior art. However, the initial equipment costs and the maintenance expenses are higher.

Two measurement devices 26 are provided for each of the carriage groups 11 rotational about the vertical axes 23. They detect the positions of the wheels 12, leading in reference to the two drive directions, with regards to their alignment in the direction perpendicular in reference to the rail 1. The alignment of a wheel 11 in reference to the rail 1 with regards to its position perpendicular to the longitudinal extension of the rail 1 is called the track position within this document. The track position value a shows the offset of the wheel in reference to the central alignment to the rail 1. In case of a wheel with wheel flanges 14, 15, as preferred for the leading wheels 12 in reference to the two drive directions, the distance of one of the wheel flanges 14, 15 in reference to the adjacent rail flange 27 could also be used as the track position value a.

The track position of the wheel 12, leading in reference to the respective drive direction, of a carriage group 11 is largely determining for the positions of the wheels 12 of the carriage group 11 in reference to the rails and for the forces applied by the wheel flanges 12 upon the rail flanks. Instead of detecting the wheel front-most in reference to the present drive direction the measurement device can generally also detect the track position of the wheels located in front of the vertical axis 23 about which the carriage group 11 can be rotated. The wheels located in the drive direction in front of the vertical axis 23, about which the carriage group 11 can be rotated, are here the respectively “leading” wheels.

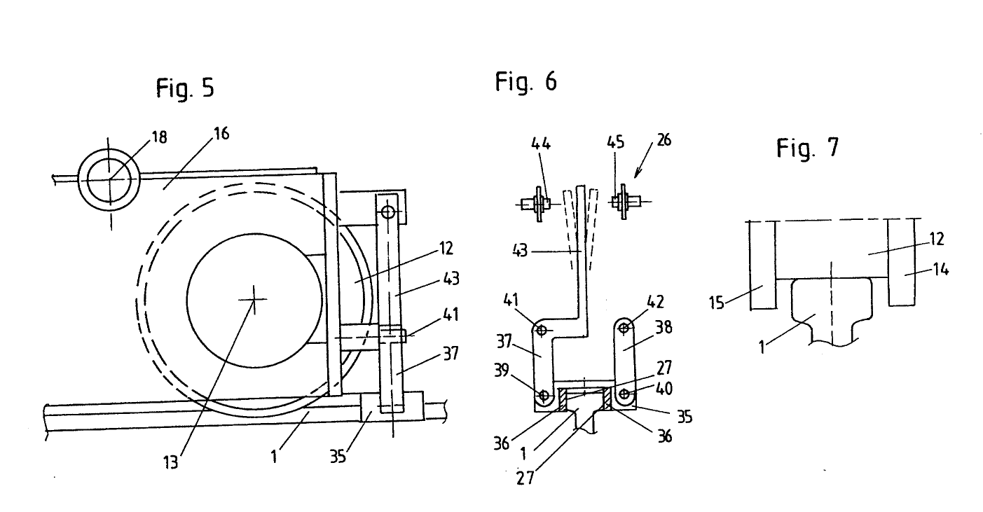

An example for a potential embodiment of a measurement device 26 is particularly discernible from FIGS. 5 and 6. A brace 35 contacts with sideway linings 36 the two rail flanks 27 in a gliding fashion. The brace 35 is supported at the first and second pivotal arms 37, 38, rotational about horizontal axes 39, 40 positioned perpendicularly in reference to the axes 13 of the wheels 12. Further, the pivotal arms 37, 38 are supported above the axes 39, 40 rotational about horizontal axes 41, 42 positioned perpendicular in reference to the axes 13 of the wheels 12, which axes 41, 42 are mounted fixed to the subframe 16, namely preferably in the area of the end of the subframe 16. The distance of the brace 35 from the axis 13 of the wheel 12, leading in reference to the respective drive direction, is relatively short, preferably smaller than the diameter of said wheel 12. The first pivotal arm 37 comprises an extension arm 43, projecting upwards in reference to the axis 41, forming a two-armed lever. In a displacement of the wheel 12 in reference to the rail 1 in the direction perpendicular to the rail 1, a parallel displacement of the section of the subframe 16, located in the area of said wheel 12, occurs in reference to the rail 1 and thus a displacement of the first and the second pivotal arms 37, 38 and the extension arm 43. The position of the extension arm 43 corresponding to the central track position of wheel 12 is shown in FIG. 6 in a continuous line, two positions of the extension arm 43 for positions of track offset in the two perpendicular directions are also indicated by dot-dash lines in FIG. 6.

The pivotal position of the extension arm 43 is detected for example by inductive measurement sensors 44, 45. In the simplest case, it is possible to embody the two measurement sensors 44, 45 as switches mechanically operated by the extension arm 43.

It is also possible, for example to arrange the respective measurement device 26 at the subframe 26 on the side facing the vertical axis 23, about which the carriage group 11 can be rotated.

An actuator 28 acts between the carriage group 11 and the corresponding end carriage 10, as for example shown embodied in the form of a piston-cylinder unit. Said unit is arranged between a connecting bar 46 mounted at the end carriage 10 and a connecting bar 47 mounted at the rocker arm 19. By a force impinged by the actuator 28, a torque m is applied upon the carriage group 11, acting about the vertical axis 23.

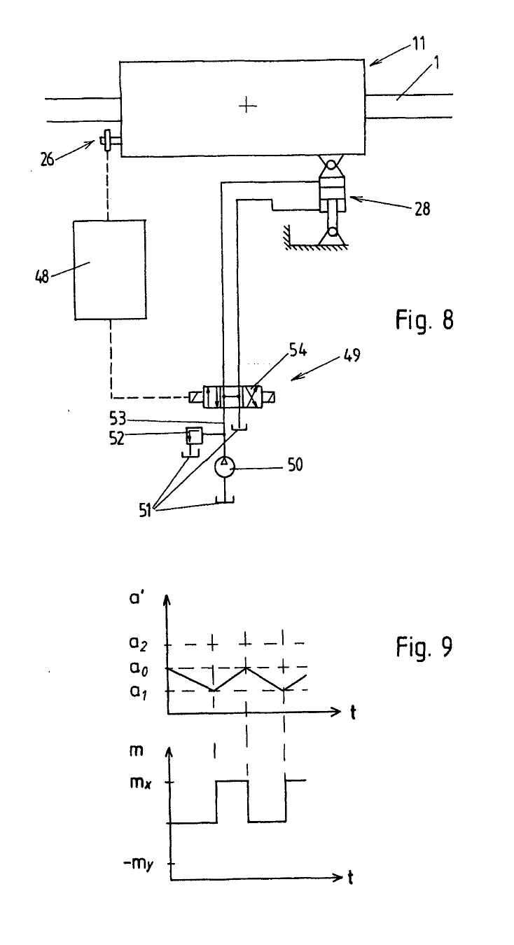

The actuator 28 is controlled by a control device 48, 49 depending on the track position value output by the measurement device 26. Here, a force is adjusted as the variable at the actuator 28. An exemplary embodiment of the entire control circuit is shown schematically in FIG. 8. The control device comprises a control unit 48, which is supplied with the track position value detected by the measurement device 26, and an actuator control device 49. In the exemplary embodiment shown, the actuator control device 49 is formed by hydraulic elements. Here, a pump 50 supplies hydraulic oil from a reservoir 51. The maximum pressure occurring in the hydraulic line 53 is adjusted via a pressure valve 52. A 4/3-way valve 54 is controlled by a control unit 48. Depending on the setting of the 4/3-way valve 54 the actuator 28 is opened or the actuator 28 impinges a force in one or the other direction, i.e. a torque m is impinged upon the carriage group 11 acting in one or the other rotational direction. This torque m represents the variable of the control circuit. The control path is formed by the carriage group 11 running on the rail 1, as schematically shown in FIG. 8.

In the exemplary embodiment shown, the variable may only represent three values, namely a torque 0, a torque with an amount mₓ acting in one rotational direction, or a torque with the amount m_{y} acting in the other rotational direction. The amount mₓ and/or m_{y} of the torque is here preset, in the exemplary embodiment shown by adjusting the pressure value of the pressure valve 52.

The presetting may occur after the gantry crane has been completed, according to the horizontal forces which are caused by the deviations of the axes 13 of the wheels 12 of a carriage group 11 in reference to the alignments parallel thereto.

In a predetermined central range of the track position value, the torque value 0 is adjusted by the control device, i.e. in the exemplary embodiment shown by adjusting the appropriate setting of the 4/3-way valve 54 via the control unit 48. This central range is equivalent to the track position value a, which ranges from an amount a₁ to a₂. The wheel flanges 14, 15 are spaced apart from the rail flanges 27 in the range of the track position value from a₁ to a₂. When for example in the central position of the wheel 12 in reference to the rail 1 (=track position value a₀) the distances of the wheel flanges 14, 15 from the rail flanks amount to 20 mm each, the distance of the wheel flange 14 from the rail flank 27 might be 5 mm for the track position value a₁ and 35 mm for the track position value a₂.

When the central range a₁ to a₂ is exceeded, the control unit 48 will appropriately adjust the 4/3-way valve 54 such that a torque mₓ and/or −m_{y} is impinged upon the carriage group 11 counteracting any further approaching and/or separating of the wheel flange 14 to the rail flank 27 and/or away from the rail flank 27.

In order to detect if the track position value a corresponding to the present track position is within the range a₁ to a₂ or above or below said range, the control unit 48 comprises a comparator unit. The control unit 48 comprises a control unit to address the 4/3-way valve 54.

In the following, a control process is explained in greater detail using the example of FIG. 9. At the beginning of the displacement of the gantry crane, the wheel 12 of the carriage group 11, leading in reference to the drive direction, shows an average track position a₀, for example. As a consequence of horizontal forces acting here and/or tolerances in the position of the track over the course of the displacement of the crane a change of the track position occurs, in the exemplary embodiment shown in the direction towards the value a₁. Factors for the occurring horizontal force are particularly the deviations of the axial positions of the wheels 12 of a respective carriage group 11, overall not compensating each other in reference to their parallel alignments, and wind loads occurring. When the value of the track positional is reached, the carriage group 11 is impinged with the torque mₓ. The distance from the rail flank 27 increases thereby. When a predetermined track position value a is reached, for example when the central position a₀ is assumed once again, the carriage group 11 is released. The described control process is successively repeated.

When the horizontal forces act in connection with the alignment of the track position such that the value of the track position a₂ is reached, a torque −m_{y} is impinged upon the carriage group 11 acting in the opposite direction.

For example, instead of adjusting the force of the impinging torque by a pressure valve 52a, pump 50 could also be used for this purpose with its feed pressure being adjustable.

Instead of hydraulically acting actuators 28, other actuators could also be used, for example mechanically or electromechanically acting actuators. For example, in the case of an electrically controlled actuator, the device could directly be controlled by the control part of the control unit 48.

Instead of only three different values for the variable (0, mₓ, −m_{y}, with the amounts mₓ and m_{y} being identical or different), more than three values may be provided for the variable, for example, in addition to the 0-value, two different forces for the torque, which are impinged in the two rotational directions. They may be activated in case of predetermined actual values of the variable a. A continuous control of the torque may also be provided.

More than one actuator 28 per carriage group 11 may be provided as well.

The measurement device 26 may also be embodied in a different manner than the one shown. For example, one part may be provided cooperating with only one rail flank 27, and supported rotational in reference to the subframe 16.

Legend for the reference characters

| | |
|---|---|
| 1 | rail |
| 2 | leg |
| 3 | leg |
| 4 | leg |
| 5 | leg |
| 6 | transverse beam |
| 7 | transverse beam |
| 8 | trolley |
| 9 | connecting bar |
| 10 | end carriage |
| 11 | carriage group |
| 12 | wheel |
| 13 | axis |
| 14 | wheel flange |
| 15 | wheel flange |
| 16 | subframe |
| 17 | rocker arm |
| 18 | axis |
| 19 | rocker arm |
| 20 | axis |
| 21 | drive engine |
| 22 | central joint |
| 23 | vertical axis |
| 24 | horizontal axis |
| 25 | connection device |
| 26 | measurement device |
| 27 | rail flank |
| 28 | actuator |
| 29 | guide |
| 30 | guide |
| 31 | joint |
| 32 | joint |
| 33 | horizontal axis |
| 34 | horizontal axis |
| 35 | brace |
| 36 | slideway lining |
| 37 | first pivotal arm |
| 38 | second pivotal arm |
| 39 | axis |
| 40 | axis |
| 41 | axis |
| 42 | axis |
| 43 | extension arm |
| 44 | measuring sensor |
| 45 | measuring sensor |
| 46 | connecting bar |
| 47 | connecting bar |
| 48 | control unit |
| 49 | actuator control device |
| 50 | feed pump |
| 51 | reservoir |
| 52 | pressure valve |
| 53 | hydraulic line |
| 54 | 4/3-way valve |

1. A gantry crane comprising a carriage serving to displace the gantry crane along a straight track formed by parallel rails (1), a plurality of carriage groups (11), each of the carriage groups (11) comprises at least two wheels (12) supported rotationally by a subframe (16) and spaced apart from each other in a longitudinal direction of a respective one of the rails (1), and with at least two of the carriage groups being connected to at least one end carriage (10) of the gantry crane, rotational about a vertical respective axis (23), with for at least one of the carriage groups (11) connected to the respective end carriage (10) and rotational about the respective vertical axis (23), at least one measurement device (26) is provided, the at least one measurement device is adapted to detect a track position of at least one of the wheels (12) of the carriage group (11) in reference to the rail (1) on which it rolls, and is adapted to output a track position value (a) corresponding to a respective track position, an actuator (28) is provided acting between the carriage group (11) and the respective end carriage (10), which is controlled via a control device (48, 49), which receives the track position value (a) output by the measurement device (26), and is adapted to impinge the carriage group (11) with a torque (m) about the vertical axis (23) that is determined by said control.

2. A gantry crane according to claim 1, wherein at least one of the measurement devices (26) is provided for each of the two drive directions of the gantry crane to detect the track position of the wheel (12) of the carriage group (11), positioned in front of the vertical axis (23), about which the carriage group (11) is rotational, in reference to a respective drive direction of the gantry crane.

3. A gantry crane according to claim 1, wherein the torque (m) impinged by the actuator (28) upon the carriage group (11) is set to a value 0 by the control device (48, 49) for a central range (a₁-a₂) of the track position of the wheel (12) detected by the measurement device (26).

4. A gantry crane according to claim 3, wherein the torque (m) impinged by the actuator (28) upon the carriage group (11) is set to a constant, predetermined amount (mₓ, m_{y}), for the track position of the wheel (12) which is located at one side outside the central range (a₁-a₂), with a rotational direction of the torque (m) being different depending on a side at which the track position has left the central range (a₁-a₂).

5. A gantry crane according to claim 1, wherein the actuator (28) is a piston-cylinder unit acting between the carriage group (11) and the respective end carriage (10).

6. A gantry crane according to claim 1, wherein the measurement device (26) comprises a part (35), supported rotationally at the subframe (16) at which the wheel (12) to be detected is rotationally supported, and cooperates at least with one rail flank (27).

7. A gantry crane according to claim 6, wherein the measurement device comprises a brace (35) cooperating with both of the rail flanks (27), which is rotationally supported at rocker arms (37, 38) that are in turn supported rotationally at the subframes (16).

8. A gantry crane according to claim 1, wherein each of the carriage groups (11) comprises two or more of the subframe (16) with at least two of the wheels (12) each, spaced apart from each other in the longitudinal direction of the respective rail (1) and supported rotationally at the subframe (16), and the respective carriage group (11) in its entirety is connected to the end carriage (10), rotational about the single vertical axis (23).

9. A gantry crane according to claim 1, wherein the carriage groups (11) are each arranged directly below the respective legs (2-5) of the gantry crane.
